(19) United States
(12) Patent Application Publication
(10) Pub. No.: US 2020/0201858 A1
(43) Pub. Date: Jun. 25, 2020

(54) INFORMATION PROCESSING APPARATUS AND NON-TRANSITORY COMPUTER READABLE MEDIUM STORING PROGRAM

(71) Applicant: FUJI XEROX CO., LTD., TOKYO (JP)

(72) Inventors: Ryota OZAKI, Kanagawa (JP); Wataru UNO, Kanagawa (JP); Noriji KATO, Kanagawa (JP)

(73) Assignee: FUJI XEROX CO., LTD., TOKYO (JP)

(21) Appl. No.: 16/387,558

(22) Filed: Apr. 18, 2019

(30) Foreign Application Priority Data
Dec. 21, 2018 (JP) 2018-240134

(51) Int. Cl. G06F 16/2458

(52) U.S. Cl. CPC G06F 16/2477

(57) ABSTRACT

An information processing apparatus includes a group generation unit that generates search action groups including plural search actions, based on occurrence time of each of search actions occurring along a time series, and a specifying unit that specifies a search action included in an identical search event, based on a group relevance between the search action groups.

### CROSS-REFERENCE TO RELATED APPLICATIONS

This application is based on and claims priority under 35 USC 119 from Japanese Patent Application No. 2018-240134 filed Dec. 21, 2018.

### BACKGROUND

### (i) Technical Field

The present invention relates to an information processing apparatus and a non-transitory computer readable medium storing a program.

### (ii) Related Art

A search method or the like may be recommended by extracting a series of search actions occurring to search for information (for example, a series of search actions occurring until target information is searched, a series of search actions occurring before the intention of a user's search changes, or the like) as a search event and analyzing the search event.

In JP2017-146926A, an apparatus is described which stores keywords used for search with information on plural objects selected from a search result searched by using the keywords, in association with each other, as search history information, in a storage unit, calculates similarity between plural objects corresponding to the keyword, based on the search history information stored in the storage unit, and determines ambiguity of the keyword from the similarity.

In JP2009-169541A, a server is described that obtains a degree of correlation between information (title and abstract) related to a Web page selected by a user in query search and the searched query and presents a recommended query.

### SUMMARY

Aspects of non-limiting embodiments of the present disclosure relate to an information processing apparatus and a non-transitory computer readable medium storing a program, for specifying search actions included in an identical search event more accurately, in a case of extracting occurred search action as an identical search event, for searching target information, as compared with a case of using only a relevance between search actions.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a group generation unit that generates search action groups including a plurality of search actions, based on occurrence time of each of search actions occurring along a time series; and a specifying unit that specifies a search action included in an identical search event, based on a group relevance between the search action groups.

### BRIEF DESCRIPTION OF THE DRAWINGS

Exemplary embodiment(s) of the present invention will be described in detail based on the following figures, wherein:

FIG. 1 is a block diagram illustrating a configuration of an information processing system according to an exemplary embodiment;

FIG. 2 is a block diagram illustrating a configuration of an information processing apparatus according to the present exemplary embodiment;

FIG. 3 is a block diagram illustrating a configuration of a processing unit according to the present exemplary embodiment;

FIG. 4 is a diagram showing a flowchart relating to a learning process of a discriminator that calculates an action relevance;

FIG. 5 is a diagram showing a flowchart relating to a process by the information processing apparatus according to the present exemplary embodiment;

FIG. 6 is a diagram showing a list of search actions;

FIG. 7 is a diagram showing extended search action groups;

FIG. 8 is a diagram showing an action relevance;

FIG. 9 is a diagram showing extended search action groups;

FIG. 10 is a diagram showing an action relevance; and

FIG. 11 is a diagram showing profiling information.

### DETAILED DESCRIPTION

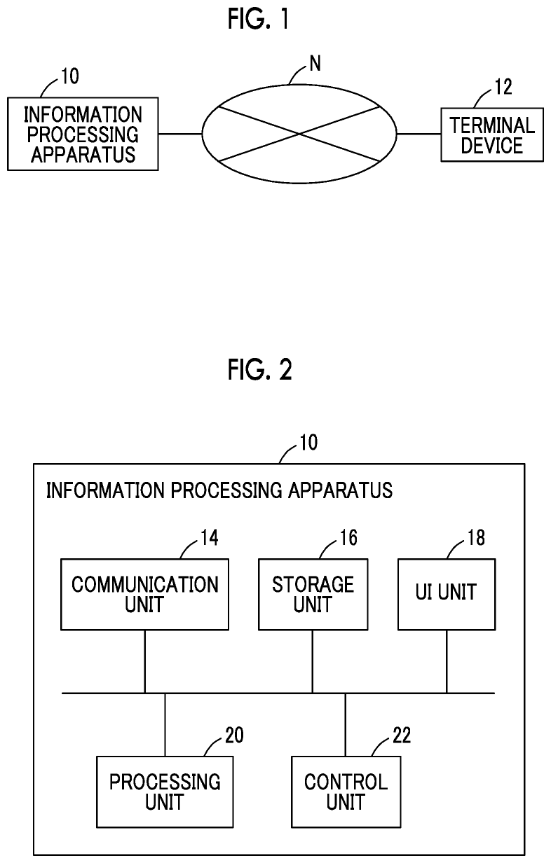

With reference to FIG. 1, an information processing system according to an exemplary embodiment of the present invention will be described. FIG. 1 illustrates an example of the information processing system according to the present exemplary embodiment.

The information processing system according to the present exemplary embodiment includes an information processing apparatus 10 and one or plural terminal devices 12. Although one terminal device 12 is shown in FIG. 1, plural terminal devices 12 may be included in the information processing system. The information processing apparatus 10 and the terminal device 12 have a function of communicating with each other through a communication path N, for example. The communication path N is, for example, the Internet or another network (for example, a LAN). Of course, the information processing apparatus 10 and the terminal device 12 may directly communicate with other apparatuses without passing through the communication path N. Further, an apparatus such as a server may be included in the information processing system.

The information processing apparatus 10 is configured to acquire information indicating search actions occurring to search for information and specify search actions included in the identical search event. Hereinafter, the information indicating the search action is referred to as “search action information”. Information to be searched is document data, text data, image data (still image data, moving image data), Web page, audio data, and the like. Of course, information other than the above information may be searched. In addition, the information to be searched may be information stored in a database, information stored on a Web server, a file server or a cloud, or information stored in the terminal device 12 used by the user or the like, or information stored in another storage.

The terminal device 12 is a personal computer (PC), a tablet PC, a smartphone, a mobile phone, or the like, and is used by the user at the time of searching for information, for example.

In addition, the user may search for information using the information processing apparatus 10. Further, the terminal device 12 may be incorporated in the information processing apparatus 10.

Hereinafter, with reference to FIG. 2, the configuration of the information processing apparatus 10 will be described in detail. FIG. 2 illustrates an example of the configuration of the information processing apparatus 10.

A communication unit 14 is a communication interface, and has a function of transmitting information to other apparatuses and a function of receiving information received from other apparatuses. The communication unit 14 may have a wireless communication function or may have a wired communication function.

A storage unit 16 is one or plural storage areas for storing various types of information. Each storage area may be defined as one or plural storage devices (for example, a physical drive such as a hard disk drive and a memory) provided in the information processing apparatus 10, or may be defined as a logical partition or a logical drive set in one or plural storage devices.

A UI unit 18 is a user interface, and includes a display unit and an operation unit. The display unit is, for example, a display device such as a liquid crystal display or an EL display. The operation unit is an input device such as a keyboard or a mouse. A user interface (for example, a touch panel or the like) having both a display unit and an operation unit may be used as the UI unit 18. Note that the information processing apparatus 10 may not have the UI unit 18.

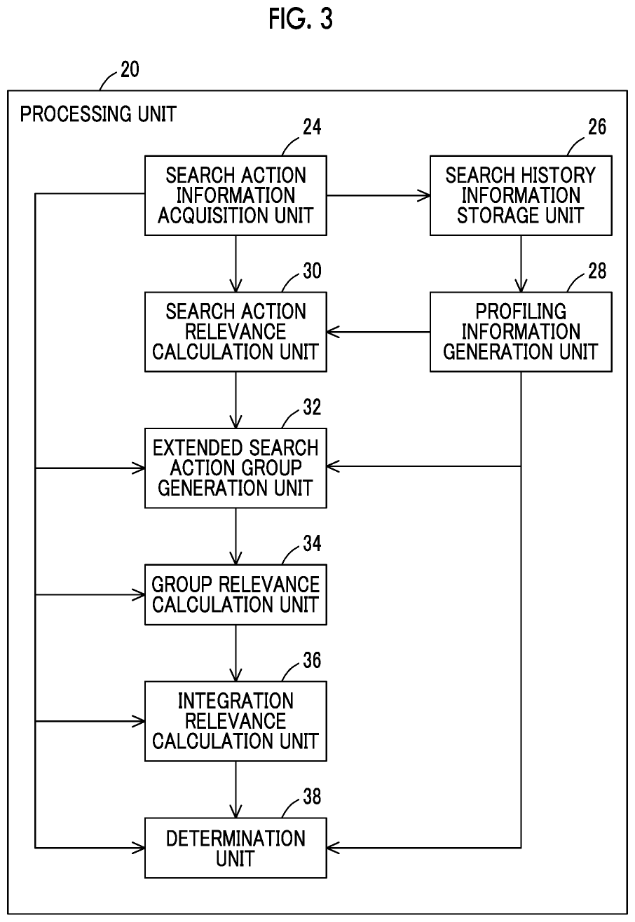

The processing unit 20 is configured to acquire search action information and to specify search actions included in the identical search event. Details of the processing unit 20 will be described later with reference to FIG. 3.

A control unit 22 is configured to control the operation of each unit of the information processing apparatus 10.

Hereinafter, with reference to FIG. 3, the configuration of the processing unit 20 will be described in detail. FIG. 3 illustrates an example of the configuration of the processing unit 20.

A search action information acquisition unit 24 is configured to acquire search action information. For example, the search action information acquisition unit 24 may acquire search action information from a database, a Web server, a file server, a cloud, or the like in which the search is performed, or may acquire search action information from the terminal device 12 used for the search. The search action information acquisition unit 24 may acquire search action information every time a search is performed by the user, or may acquire search action information collectively at predetermined time intervals.

The category of the concept of the search action includes, for example, an action of instructing a search using a query or the like by the user and a process of outputting (for example, displaying) the search result. For example, in a case where the user instructs a search using a certain query, a search result thereof is displayed, and the user views the search result, the series of actions and processes constitute one search action. In a case where the user instructs a search using another query, a search result thereof is displayed, and the user views the search result, the series of actions and processes constitute another one search action.

Examples of search action information include information indicating a query used for the search, information indicating the search result, information indicating the time related to the search, information on the tab of the Web browser used for the search, information indicating the relevance between the query and the search result, or the like. At least one piece of information of these may be included in the search action information. Information concerning the search other than these pieces of information may be included in the search action information. Further, the search action information includes user identification information (for example, a user name, a user ID, and the like) for identifying the user who performs the search. Instead of the user identification information or together with the user identification information, device identification information (for example, a device name, a MAC address, an IP address, or the like) for identifying the device (for example, the terminal device 12) used for the search may be included in the search action information. The tab of the Web browser is a user interface for switching and displaying the Web page.

The query is, for example, a keyword input by the user for search, or a search condition (for example, a search expression such as AND search or OR search, or the like) selected by the user. The search result is, for example, the content, abstract, title, or the like described in the web page, document data, or the like obtained by the search. In addition to these, image data, audio data, or the like obtained by the search may be included in the information indicating the search result. The time related to the search is, for example, the time at which the search is performed (for example, the date and time), the time at which the search result is accessed (for example, the date and time), the time at which the user views the search result (for example, the date and time, the length of time at which the user views the search result, or the like). The browsing time is, for example, the time during which the search result is being displayed (for example, the date and time, the length of time during which the search result is being displayed, or the like). The information on the tabs includes, for example, the time when the user creates tab in the Web browser (for example, date and time), the time when the tab is closed (for example, date and time), the tab identification information for identifying the tab (for example, tab ID), or the like. The relevance between the query and the search result is, for example, the similarity between the query and the title, snippet and contents included in the search result, the similarity between the search results, and the like. These degrees of similarity are calculated in a database which is an acquisition source of search action information, a Web server, a file server, a cloud, a terminal device 12, or the like, for example. The search action information acquisition unit 24 may calculate these degrees of similarity.

The search history information storage unit 26 is configured to acquire information (hereinafter referred to as “search history information”) indicating the search history at the time of each search and store the acquired information in the storage unit 16. The search history information storage unit 26 may acquire search history information from a database, a Web server, a file server, a cloud, or the like in which the search is performed, or may acquire search history information from the terminal device 12 used for the search. The search history information storage unit 26 may acquire search history information every time a search is performed by the user, or may acquire search history information collectively at predetermined time intervals.

Further, the search history information storage unit 26 is configured to store search action information in the storage unit 16. The search history information may be included in the search action information. In this case, the search history information storage unit 26 acquires search history information from the search action information acquisition unit 24.

The search history information includes, for example, information on a tab (movement from a new page or another page) when the user opens each viewed page, information indicating the number of viewed pages in each search, information indicating the ranking of the page viewed by the user in each search, the information indicating the query used for the search, the information indicating the page viewed by the user, the information indicating the time required for the search, information indicating the time when the user views the search result, or the like. At least one of these pieces of information may be included in the search history information. Information relating to the search history, other than these pieces of information, may be included in the search history information. Further, the search history information includes user identification information for identifying the user who performs the search. Instead of the user identification information or together with the user identification information, device identification information for identifying the device used for the search may be included in the search action information.

The profiling information generation unit 28 is configured to generate profiling information indicating the characteristics of the search for each user, based on the search history information of each user stored in the storage unit 16. The profiling information generation unit 28 may generate profiling information for each group such as an organization to which plural users belong. Examples of the profiling information include information indicating a multitask degree, information indicating a search speed, information indicating a browsing time, information indicating a browsing speed, information indicating an interest field, or the like. At least one of these pieces of information may be included in the profiling information.

The multitask degree is calculated based on the number of tabs used simultaneously for searching (the number of tabs opened simultaneously), the number of times of switching between plural tabs, and the like. As an example, the multitask degree is a value obtained by multiplying the number of tabs that are simultaneously open within a predetermined time (for example, n minutes) by the number of times of switching of the tab. The search speed is calculated based on the time interval of each search. As an example, the search speed is the average time interval between search actions. The browsing time is calculated based on the length of time during which the user browses each piece of information such as a Web page, a document, an image, and the like in each search. The browsing speed is, for example, the average browsing time of each piece of information such as a Web page, a document, an image, and the like. The interest field is specified based on, for example, the query used for the search, the page viewed by the user, and the like. As an example, the interest field is specified by a word included in information such as a Web page, a document, an image, and the like viewed by the user, a word included in the query, or the like. These calculations and specifying processes are performed by the profiling information generation unit 28.

Since the profiling information indicates the multitask degree, the search speed, the browsing time, or the like, it can be said that the profiling information indicates the search capability of the user. In other words, it is estimated that the user having a faster search speed is a user who is accustomed to the search or a user with a higher search capability. Further, it is estimated that the user having a high multitask degree (for example, the user having more tabs used simultaneously) is a user who is accustomed to the search or a user with a high search capability. It can also be said that the profiling information indicates the individuality, features, habits, or the like of the user's search.

The search action relevance calculation unit 30 is configured to acquire plural pieces of search action information from the search action information acquisition unit 24, and to calculate the relevance between search actions (hereinafter referred to as “action relevance”). The search action relevance calculation unit 30 calculates action relevance between search actions for each user who performs the search or for each device such as the terminal device 12 used for the search, for example.

The search action relevance calculation unit 30 calculates the action relevance, for example, based on the Levenshtein distance between the queries used in each search action, the similarity between the queries, the number of edited texts, the similarity between the search results of search actions (similarity of titles, snippets, contents, URLs, or the like), or the like. The search action relevance calculation unit 30 may calculate an action relevance by combining plural values among the above values. Further, a discriminator determining whether or not search actions are related to each other may be created by learning in advance, using these pieces of information as inputs, by a machine learning technique such as Deep Neural Network, Random Forest, Adaboost, Gradient Boosting, or the like. The output value of the discriminator may be used as action relevance. The search action relevance calculation unit 30 may acquire the profiling information of each user and create a discriminator for each user or for each group, based on the profiling information of each user. Further, the search action relevance calculation unit 30 calculates the similarity of the query and the similarity of the search result, based on the feature amount created by the method such as word 2 vec and seq 2 vec, for example.

An extended search action group generation unit 32 is configured to acquire one or plural pieces of search action information from the search action information acquisition unit 24, and generate an extended search action group including one or plural search actions indicated by the one or plural pieces of search action information. The extended search action group generation unit 32 acquires plural pieces of search action information for each user who performs search or for each device such as the terminal device 12 used for the search, for example, and generates search action groups including plural search actions, based on occurrence time of each of search actions occurring along a time series. The occurrence time of the search action is, for example, the time at which the search is performed (for example, the date and time), the time at which the search result is accessed (for example, the date and time), the time at which the user views the search result (for example, the date and time), or the like.

The extended search action group generation unit 32 generates an extended search action group including one or plural search actions occurring within a predetermined time range with the occurrence time of the reference search action as a reference, for example. The extended search action group generation unit 32 generates an extended search action group for each reference search action, by changing the reference search action. The time range may be determined in advance based on preliminary experiments or the like, or may be changed by the user, the administrator, or the like. For example, in a case of paying attention to a certain search action, the extended search action group generation unit 32 generates an extended search action group including one or plural search actions occurring within the time range with the occurrence time of the search action as a reference. Similarly, the extended search action group generation unit 32 generates an extended search action group including one or plural search actions occurring within the time range with the occurrence of another search action as a reference.

The extended search action group generation unit 32 may acquire the profiling information from the profiling information generation unit 28 and may change the time range according to the search capability of the user indicated by the profiling information. As another example, the extended search action group generation unit 32 may change the time range according to the relevance between the query included in the specific search action and the search result. These processes will be described in detail later.

The group relevance calculation unit 34 is configured to calculate the relevance between extended search action groups (hereinafter referred to as “group relevance”). For example, the group relevance calculation unit 34 may calculate the overlapping rate of the search actions between the respective extended search action groups as group relevance, or may calculate the group relevance by performing weighting according to the occurrence time difference on the action relevance between search actions included in the extended search action group. For example, the weighting decreases as the occurrence time difference increases. Details of the calculation of the group relevance will be described later in detail.

The integration relevance calculation unit 36 is configured to calculate the integrated relevance between search actions (hereinafter referred to as “integration relevance”). For example, the integration relevance calculation unit 36 determines the integration relevance between search actions, based on action relevance between search actions and the group relevance. Specifically, the integration relevance calculation unit 36 calculates the integration relevance between the search actions by multiplying each action relevance by the group relevance. The integration relevance calculation unit 36 may perform weighting such that integration relevance increases as the occurrence time between search actions is closer, or may perform weighting such that integration relevance for search actions using the identical tab increases.

The determination unit 38 is configured to determine whether or not search actions are included in the identical search event, based on the group relevance or the integration relevance. The determination unit 38 functions as an example of a specifying unit that specifies search actions included in the identical search event.

For example, in a case where the group relevance between extended search action groups is equal to or larger than the threshold, the determination unit 38 determines that the plural search actions included in each extended search action group are included in the identical search event. As another example, in a case where the integration relevance between the search actions becomes equal to or larger than the threshold, the determination unit 38 may determine that each search action is included in the identical search event. The threshold may be determined in advance, for example, or may be changed by the user, the administrator or the like. The determination unit 38 may acquire the profiling information from the profiling information generation unit 28, and may change the threshold according to the user's search capability. Details of this process will be described later.

The processing unit 20 may be provided in the terminal device 12 and the process by the processing unit 20 may be performed by the terminal device 12, or the processing unit 20 may be provided in a device such as a server and the process by the processing unit 20 may be performed by the device.

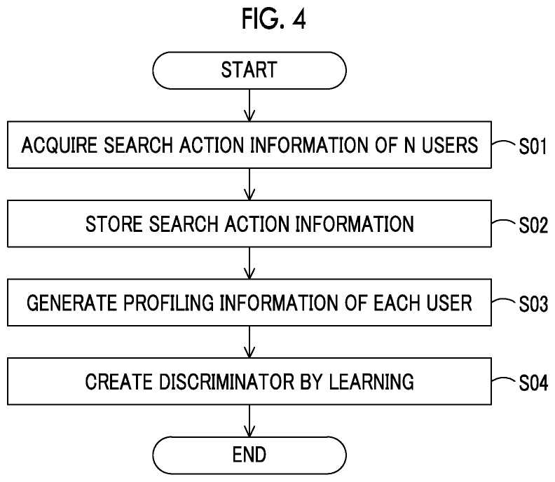

Hereinafter, with reference to FIG. 4, a learning process of a discriminator for calculating an action relevance will be described. FIG. 4 shows an example of a flowchart relating to the learning process.

The search action information acquisition unit 24 acquires search action information (including search history information) of N users (S01). The search history information storage unit 26 stores the search action information in the storage unit 16 (S02). The profiling information generation unit 28 generates profiling information of each user, based on the search history information (S03). The search action relevance calculation unit 30 calculates the Levenshtein distance between the queries used in each search action, the similarity between the queries, the number of edited texts, the similarity between the search results of search actions (similarity between titles, snippets, contents, URLs, or the like), and uses the calculated values as feature amounts to create by learning a discriminator that determines whether or not search actions are related to each other (S04). The action relevance may be calculated using the discriminator created in this way.

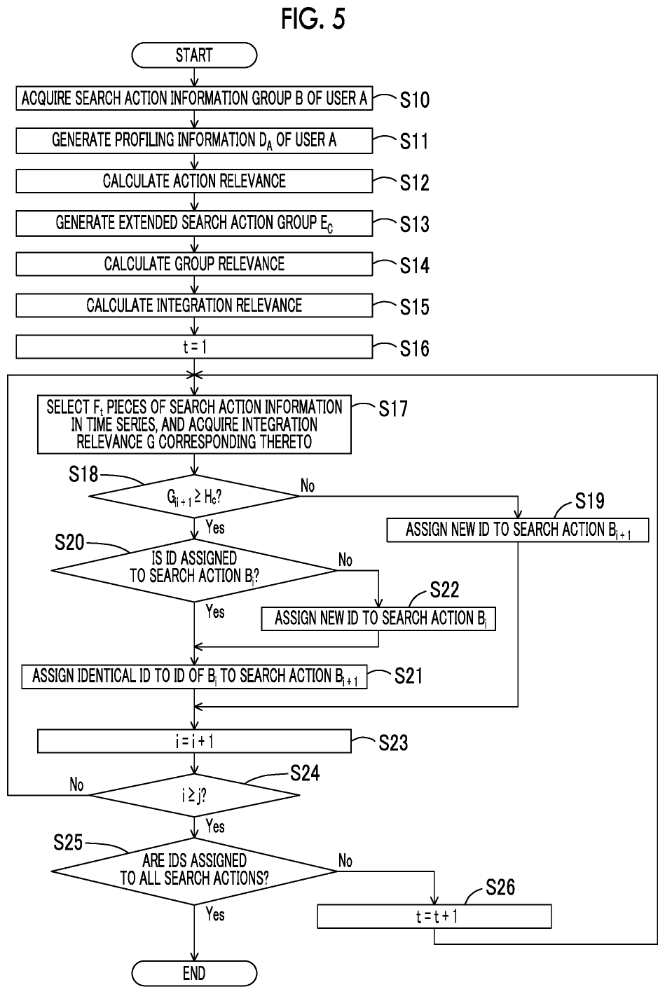

Hereinafter, a process by the information processing apparatus 10 according to the present exemplary embodiment will be described with reference to FIG. 5. FIG. 5 shows a flowchart relating to this process. In the following description, it is assumed that a search event related to the search action of the user A is extracted.

The search action information acquisition unit 24 acquires plural pieces of search action information (including search history information) including the user identification information of the user A (S10). Here, the search action information pieces B₀ to B_{c} are acquired, and these pieces of information constitute search action information group B{B₀, . . . , B_{c}}.

Next, the profiling information generation unit 28 generates the profiling information D_{A} of the user A, based on the search action information group B (S11).

Next, the search action relevance calculation unit 30 calculates an action relevance between search actions included in the search action information group B (S12). As described above, as action relevance, Levenshtein distance and similarity between queries or the like may be calculated, or the discriminator created by learning may be used.

Next, the extended search action group generation unit 32 generates an extended search action group E_{c}{E_{c1}, . . . , E_{c2}}r based on the search action information group B (S13). C1, C2 are set for each search action. The extended search action group generation unit 32 may change the time range used when generating the extended search action group, based on the profiling information of the user A.

Next, the group relevance calculation unit 34 calculates the group relevance between the extended search action groups (S14).

Next, the integration relevance calculation unit 36 calculates the integration relevance based on action relevance between search actions and the group relevance (S15).

Hereinafter, a process by the determination unit 38 is performed.

First, the determination unit 38 sets the coefficient t to “1” (S16).

Next, the determination unit 38 selects Fₜ pieces of search action information to be determined, in time series, from the search action information group B, and acquires the integration relevance G{Gᵢᵢ₊₁, . . . , Gⱼ₋₁ⱼ} corresponding to the Fₜ pieces of search action information, from the integration relevance calculation unit 36 (S17). Here, i=min, and j=max.

In a case where it is not Gᵢᵢ₊₁≥threshold H_{c} (No in S18), the determination unit 38 assigns a new search event ID to the search action Bᵢ₊₁ (S19) That is, in a case where the integration relevance is less than the threshold H_{c}, it is determined that the search action Bᵢ and the search action Bᵢ₊₁ are not search actions related to each other, a search event ID different from the search action Bᵢ is assigned to the search action Bᵢ₊₁, and the search action Bᵢ₊₁ is classified into a search event different from the search action Bᵢ. Then, the process proceeds to S23.

In the case of Gᵢᵢ₊₁≥threshold H_{c} (Yes in S18), in a case where the search event ID is assigned to the search action Bᵢ (Yes in S20), the determination unit 38 assigns the search event ID identical to the search action Bᵢ to the search action Bᵢ₊₁ (S21).

In the case of Gᵢᵢ₊₁≥threshold H_{c} (Yes in S18), in a case where the search event ID is not assigned to the search action Bᵢ (No in S20), the determination unit 38 assigns a new search event ID to the search action Bᵢ (S22), and assigns the search event ID identical to the search action Bᵢ to the search action Bᵢ₊₁ (S21).

That is, in a case where the integration relevance is equal to or larger than the threshold H_{c}, it is determined that the search action Bᵢ and the search action Bᵢ₊₁ are search actions related to each other, the search event ID identical to the search action Bᵢ is assigned to the search action Bᵢ₊₁, and the search action Bᵢ₊₁ is classified into a search event identical to the search action Bᵢ.

Next, the determination unit 38 changes the coefficient i to a coefficient i+1 (S23).

In a case where it is not i≥j (No in S24), the process proceeds to S17.

In the case of i≥j (Yes in S24), in a case where search event IDs are assigned to all search actions (Yes in S25), the process is ended.

In the case of i≥j (Yes in S24), in a case where there is a search action to which no search event ID is assigned (No in S25), the coefficient t is changed to the coefficient t+1 (S26), the process proceeds to S16, and S17 and the subsequent processes are executed. By doing so, search actions are classified into search events which are identical to each other or different from each other.

Hereinafter, the process by the information processing apparatus 10 will be described in detail with reference to specific examples.

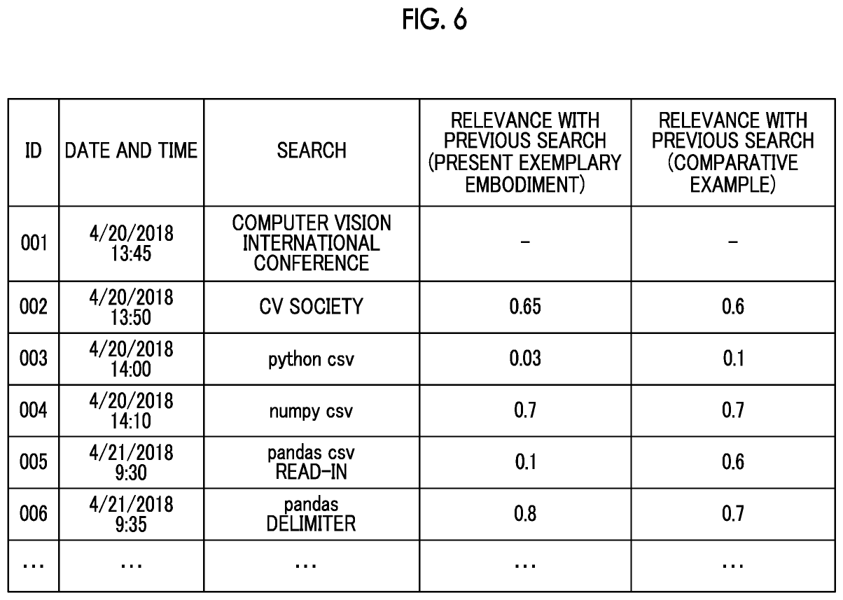

FIG. 6 shows an example of search actions for a certain user (for example, the user A). Each search action shown in FIG. 6 is a search action indicated by each piece of search action information acquired by the search action information acquisition unit 24, and each piece of search action information is stored in the storage unit 16. For example, the ID for identifying a search action, the information indicating the date and time when the search action occurs, and information indicating the specific content of the search action are associated with each other and stored in the storage unit 16. In FIG. 6, search actions are arranged in the order of date and time when each search action occurs.

For example, the search action of ID “001” is performed in 13:45 in Apr. 20, 2018, and in the search action, keywords “computer vision” and “international conference” are input for the search by the user A. Also in other search actions, the keywords for search are used by the user A.

In FIG. 6, the relevance with the previous search (the present exemplary embodiment and the comparative example) is shown as a reference. The relevance according to the present exemplary embodiment is an integration relevance taking the above-described group relevance into account. The relevance according to the comparative example is the relevance between search actions without taking the above-described group relevance into account. The relevance is shown as a reference and is not included in the search action. For example, paying attention to the search action of ID “002”, the previous search is a search action of the ID “001” one time before in the order of time. The relevance (integration relevance) according to the present exemplary embodiment between the search actions of the ID “002” and the ID “001” is “0.65”, and the relevance (action relevance) according to the comparative example is “0.6”.

The extended search action group generation unit 32 generates an extended search action group including one or plural search actions occurring within a predetermined time range with the occurrence date and time of the reference search action as a reference, for example. The extended search action group generation unit 32 generates an extended search action group by changing the reference search action.

Specifically, the extended search action group 1 including the search actions of the IDs “001” and “002” is generated, the extended search action group 2 including the search actions of the IDs “001” to “003” is generated, the extended search action group 3 including the search actions of the IDs “003” and “004” is generated, and the extended search action group 4 including the search actions of the IDs “005” and “006” is generated.

Next, the search action relevance calculation unit 30 calculates the action relevance between search actions, and the group relevance calculation unit 34 calculates the group relevance between extended search action groups.

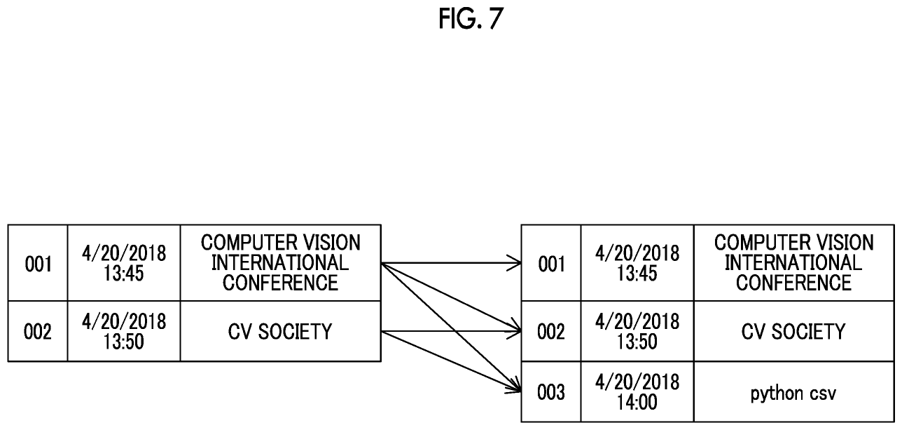

For example, action relevance and group relevance are calculated for the extended search action group 1 and the extended search action group 2. This calculation will be described in detail with reference to FIG. 7. FIG. 7 shows extended search action groups 1, 2. The search action relevance calculation unit 30 calculates the action relevance between the search action of the ID “001” and the search action of the ID “001”, the action relevance between the search action of the ID “001” and the search action of the ID “002”, the action relevance between the search action of the ID “001” and the search action of the ID “003”, the action relevance between the search action of the ID “002” and the search action of the ID “002”, and the action relevance between the search action of the ID “002” and the search action of the ID “003”. Arrows in FIG. 7 indicate combinations of search actions when action relevance is calculated.

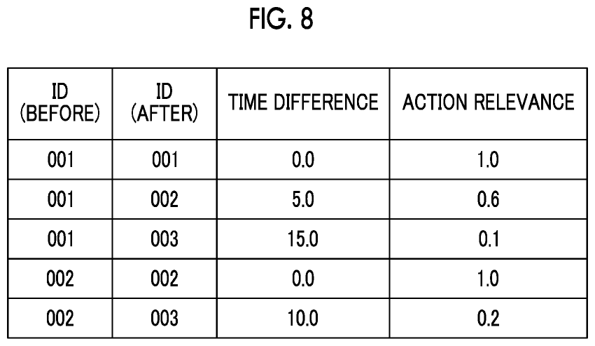

FIG. 8 shows an example of each action relevance calculated as described above. FIG. 8 also shows a difference (for example, seconds) between occurrence times of search actions. For example, the action relevance between the search action of ID “001” and the search action of ID “002” is “0.6”, and the time difference is “5.0 seconds”. As described above, the action relevance is calculated based on the similarity between queries, or the like.

The group relevance calculation unit 34 calculates the group relevance between the extended search action group 1 and the extended search action group 2.

The group relevance calculation unit 34 calculates, for example, the overlapping rate of the search action between the extended search action groups 1, 2, as the group relevance. Hereinafter, the group relevance will be referred to as “group relevance 1”. The group relevance 1 is represented by the following Expression (1). Since search actions of IDs “001” to “003” are included in the extended search action groups 1, 2, the number of all search actions (the total number of search actions of different IDs) in the extended search action groups 1, 2 is “3”. The number of overlapping search actions is “2”. Therefore, the group relevance 1 is “0.67”.

$$\frac{the number of overlapping search actions}{\begin{matrix}the number of all search actions \\ in extended search action groups\end{matrix}} = \frac{2}{3} = 0.67 \qquad ( 1 )$$

As another example, the group relevance calculation unit 34 may calculate the group relevance by performing weighting according to the occurrence time difference on the action relevance between search actions between the extended search action groups 1, 2. Hereinafter, the group relevance will be referred to as “group relevance 2”. The group relevance 2 is represented by the following Expression (2). Here, the group relevance 2 is a weighted average using the reciprocal of the occurrence time difference, and the value is “0.907”.

$$\frac{1.0 \times 1.0 + \frac{1}{5} \times 0.6 + \frac{1}{15} \times 0.1 + 1.0 \times 1.0 + \frac{1}{10} \times 0.2}{1.0 + \frac{1}{5} + \frac{1}{15} + 1.0 + \frac{1}{10}} = \frac{2.1467}{2.3667} = 0.907 \qquad ( 2 )$$

As still another example, the group relevance calculation unit 34 may calculate the group relevance which is determined by a weighted average using the reciprocal of the occurrence time difference and the reciprocal of the average of occurrence time differences between the extended search action groups 1, 2. Hereinafter, the group relevance will be referred to as “group relevance 3”. The group relevance 3 is represented by the following Expression (3). Here, the group relevance 3 is a value calculated by multiplying the weighted average using the reciprocal of the occurrence time difference by the reciprocal of the average of occurrence time differences between the extended search action groups 1, 2, and the value is “0.15”.

$$0.907 \times \frac{1}{\frac{0 + 5 + 15 + 0 + 10}{5}} = 0.907 \times \frac{1}{6} = 0.15 \qquad ( 3 )$$

As the group relevance, any one of the group relevance 1, 2 or 3 is used. A predetermined group relevance of the group relevance 1, 2 or 3 may be used, or a group relevance designated by the user, the administrator or the like may be used. Of course, in addition to the group relevance 1, 2, and 3, a value indicating the relevance between the extended search action groups may be used as the group relevance.

The integration relevance calculation unit 36 calculates the integration relevance, based on the action relevance and the group relevance between the search actions. For example, the integration relevance calculation unit 36 calculates the integration relevance between the search actions by multiplying each action relevance by the group relevance.

For example, in the example shown in FIG. 8, in a case where the group relevance 1 is used as the group relevance, the integration relevance calculation unit 36 multiplies each action relevance shown in FIG. 8 by the group relevance 1 “0.67”, thereby calculating the integration relevance between the search actions. In this case, the integration relevance between the search action of the ID “001” and the search action of the ID “002” is “0.6×0.67”, the integration relevance between the search action of the ID “001” and the search action of the ID “003” is “0.1×0.67”, and the integration relevance between the search action of the ID “002” and the search action of the ID “003” is “0.3×0.67”.

In a case where the integration relevance between the search actions becomes equal to or larger than the threshold, the determination unit 38 determines that each search action is included in the identical search event. For example, in a case where the integration relevance between the search action of the ID “001” and the search action of the ID “002” is equal to or larger than the threshold, the determination unit 38 determines that the search action of the ID “001” and the search action of the ID “002” are included in the identical search event. The same applies to other search actions. Note that group relevance 2 or 3 may be used instead of group relevance 1.

As another example, in a case where the group relevance between extended search action groups is equal to or larger than the threshold, the determination unit 38 may determine that the plural search actions included in each extended search action group are included in the identical search event. For example, since the group relevance 2, 3 is a value including action relevance, it can be said that the group relevance 2, 3 also indicates the relevance between search actions. For example, in a case where the group relevance 2 is equal to or larger than the threshold, the determination unit 38 may determine that the search actions (the search actions of the IDs “001” to “003”) included in the extended search action groups 1, 2 are included in the identical search event. The same applies to the case where the group relevance 3 is used instead of the group relevance 2.

For the groups other than the extended search action groups 1, 2, similarly to the extended search action groups 1, 2, the action relevance and the group relevance are calculated.

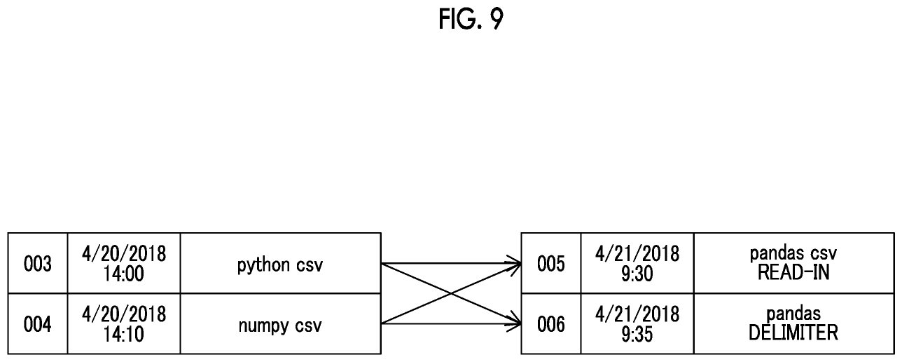

FIG. 9 shows extended search action groups 3, 4. The search action relevance calculation unit 30 calculates the action relevance between the search action of the ID “003” and the search action of the ID “005”, the action relevance between the search action of the ID “003” and the search action of the ID “006”, the action relevance between the search action of the ID “004” and the search action of the ID “005”, and the action relevance between the search action of the ID “004” and the search action of the ID “006”. Arrows in FIG. 9 indicate combinations of search actions when action relevance is calculated.

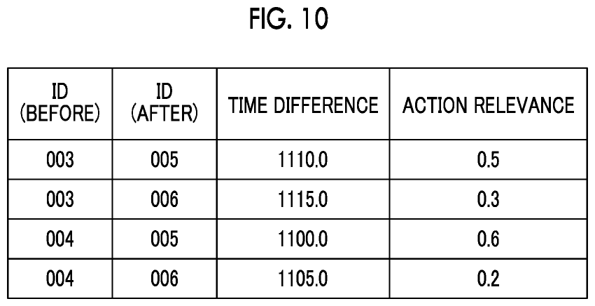

FIG. 10 shows an example of each action relevance calculated as described above. FIG. 10 also shows a difference (for example, seconds) between occurrence times of search actions.

The group relevance calculation unit 34 calculates the group relevance between the extended search action group 3 and the extended search action group 4.

The group relevance 1 between the extended search action group 3 and the extended search action group 4 is represented by the following Expression (4). Since search actions of IDs “003” to “006” are included in the extended search action groups 3, 4, the number of all search actions in the extended search action groups 3, 4 is “4”. The number of overlapping search actions is “0”. Therefore, the group relevance 1 is “0.0”.

$$\frac{the number of overlapping search actions}{\begin{matrix}the number of all search actions \\ in extended search action groups\end{matrix}} = \frac{0}{4} = 0.0 \qquad ( 4 )$$

The group relevance 2 between the extended search action group 3 and the extended search action group 4 is represented by the following Expression (5). Here, the group relevance 2 is “0.4005”.

$$\frac{\frac{1}{1110} \times 0.5 + \frac{1}{1115} \times 0.3 + \frac{1}{1100} \times 0.6 + \frac{1}{1105} \times 0.2}{\frac{1}{1110} + \frac{1}{1115} + \frac{1}{1100} + \frac{1}{1105}} = \frac{0.001446}{0.00361} = 0.4005 \qquad ( 5 )$$

The group relevance 3 between the extended search action group 3 and the extended search action group 4 is represented by the following Expression (6). Here, the group relevance 3 is “0.00000694”.

$$0.4005 \times \frac{1}{\frac{14430}{4}} = 0.4005 \times \frac{1}{3607.5} = 0.00000694 \qquad ( 6 )$$

In the example shown in FIG. 10, in a case where the group relevance 1 is used as the group relevance, the integration relevance calculation unit 36 multiplies each action relevance shown in FIG. 10 by the group relevance 1 “0.0”, thereby calculating the integration relevance between the search actions. Here, each integration relevance is “0.0”, which is less than the threshold. Therefore, the determination unit 38 determines that the search actions of the IDs “003” and “004” included in the extended search action group 3 and the search actions of the IDs “005” and “006” included in the extended search action group 4 are not included in the identical search event. Even in a case where the group relevance 2 or 3 is used instead of the group relevance 1, the determination unit 38 determines whether or not each search action is included in the identical search event by comparing the integration relevance and the threshold.

In the above example, the extended search action group 1 and the extended search action group 2 are compared, and the extended search action group 3 and the extended search action group 4 are compared, but in addition thereto, the extended search action group 1 and the extended search action group 3 may be compared, and the extended search action group 1 and the extended search action group 4 may be compared.

As described above, it is determined whether or not each search action is included in the identical search event by using the group relevance. By doing this, as compared with the case of using only the relevance between search actions, the search actions included in the identical search event are specified more accurately.

### Modification Example 1

Hereinafter, Modification Example 1 will be described. In Modification Example 1, the extended search action group generation unit 32 acquires the user's profiling information, and changes the time range used for generating the extended search action group in accordance with the search capability of the user indicated by the profiling information. For example, by narrowing the time range as the search capability is higher, the extended search action group generation unit 32 generates an extended search action group.

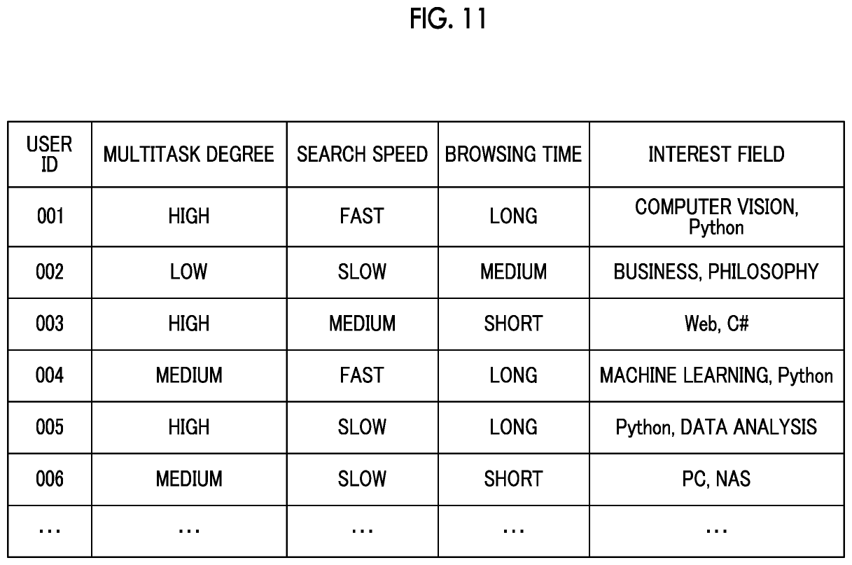

Here, an example of the profiling information will be described with reference to FIG. 11. For example, as the profiling information of each user, a user ID for identifying a user, the information indicating the multitask degree, the information indicating the search speed, the information indicating the browsing time, and the information indicating the interest field are associated with each other. These pieces of information are generated by the profiling information generation unit 28, based on the browsing history information of each user.

For example, with respect to the user of the user ID “001”, the multitask degree is “high”, the search speed is “fast”, the browsing time is “long”, and the interest field is “computer vision” and “Python”. The multitask degree, the search speed, and the browsing time may be represented by numerical values.

The higher the multitask degree, the higher the search capability is evaluated, and the faster the search speed, the higher the search capability is evaluated. Therefore, the extended search action group generation unit 32 narrows the time range as the multitask degree is higher, and narrows the time range as the search speed is faster.

The wider the time range used for generating the extended search action group, the higher the possibility that search actions that cannot be included in the identical search event are included in the identical extended search action group as noise. By narrowing the time range as the search capability is higher, such noise is removed and an extended search action group is generated. For example, it is assumed that it takes shorter time for a user with high search capability to search for target information, compared with a user with low search capability. Therefore, by narrowing the time range as the search capability is higher, the extended search action group from which noise is removed is generated, and the accuracy of the determination process of the identical search event is improved. On the other hand, it is assumed that it takes longer time for a user with low search capability to search for target information, compared with a user with high search capability. Therefore, by expanding the time range the lower the search capability, the extended search action group is generated using more pieces of search action information.

### Modification Example 2

Hereinafter, Modification Example 2 will be described. In Modification Example 2, the extended search action group generation unit 32 changes the time range used for generation of the extended search action group, according to the relevance between the query included in the reference search action for generating the extended search action group and the search result. For example, by narrowing the time range as the relevance is higher, the extended search action group generation unit 32 generates an extended search action group.

As described above, the relevance between the query and the search result is, for example, the similarity between the query and the title, snippet and contents included in the search result, the similarity between the search results, and the like.

As the relevance between the query and the search result is higher, it is estimated that the target information of the user is searched, and it is estimated that the search event ends in a shorter time. Therefore, since the extended search action group is generated by narrowing the time range as the relevance between the query and the search result is higher, compared with the case where the extended search action group is generated by expanding the time range, an extended search action group with less noise is generated, and as a result, the accuracy of the determination process of the identical search event may be increased.

### Modification Example 3

Hereinafter, Modification Example 3 will be described. In Modification Example 3, the determination unit 38 acquires the user's profiling information, and changes the threshold for determining the identical search event, according to the user's search capability indicated by the profiling information. For example, as the search capability is higher, the determination unit 38 sets the threshold to a higher value. Specifically, the determination unit 38 sets the threshold to a higher value as the multitask degree is higher, and sets the threshold to a higher value as the search speed is faster.

By setting the threshold to a higher value as the search capability is higher, search actions included in the identical search event are specified by excluding search actions with lower relevance that may be noise, so the accuracy of the determination process of the identical search event is increased.

### Modification Example 4

Hereinafter, Modification Example 4 will be described. In Modification Example 4, the determination unit 38 acquires the user's profiling information, and selects or changes the search action to be determined, according to the user's search capability indicated by the profiling information. For example, users with higher multitask degree tend to perform various types of searches in a short time. Similarly, users with faster search speeds tend to perform various searches in a short time. Therefore, compared to a user with a lower multitask degree or a user with a slower search speed, there is a high possibility that a different search event may occur between the identical search events, for example, such as the search event 1-the search event 2-the search event 1. Thus, in Modification Example 4, as the search capability is higher, the determination unit 38 selects more search actions as the search actions to be determined, and determines whether or not each search action is included in the identical search event.

The information processing apparatus 10 and the terminal device 12 are realized by, for example, cooperation of hardware and software. Specifically, the information processing apparatus 10 and the terminal device 12 include one or plural of processors such as a CPU (not shown). The functions of respective units of the information processing apparatus 10 and the terminal device 12 are realized by the one or plural processors reading and executing the program stored in the storage device (not shown). The program is stored in a storage device through a recording medium such as a CD or a DVD or through a communication path such as a network. As another example, each unit of the information processing apparatus 10 and the terminal device 12 may be realized by hardware resources such as a processor, an electronic circuit or an application specific integrated circuit (ASIC). A device such as a memory may be used for realizing the device. As still another example, each unit of the information processing apparatus 10 and the terminal device 12 may be realized by a digital signal processor (DSP), a field programmable gate array (FPGA), or the like.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a group generation unit that generates search action groups each including one or more search actions, based on occurrence time of each of the one or more search actions occurring in a time series; and
a specifying unit that specifies one or more search actions in a search event, based on a group relevance between the search action groups.

2. The information processing apparatus according to claim 1,
wherein each of the search action groups includes one or more search actions occurring within a predetermined time range set based on occurrence time of a reference search action, wherein length of the time range varies according to a search ability of a user performing the reference search action.

3. The information processing apparatus according to claim 2,
wherein the time range is narrowed, as the search ability of the user increases.

4. The information processing apparatus according to claim 1,
wherein each of the one or more search actions includes a search query and a search result, and
wherein each of the search action groups includes one or more search actions occurring within a predetermined time range set based on occurrence time of a reference search action, wherein length of the time range varies according to a relevance between a query and a search result of the reference search action.

5. The information processing apparatus according to claim 4,
wherein the time range is narrowed, as the relevance increases.

6. The information processing apparatus according to claim 1,
wherein the one or more search actions in the search event are specified based on a result of comparison between integration relevance and a threshold, the integration relevance being determined based on the group relevance, the threshold being adjusted according to a search ability of a user who performs a search action.

7. The information processing apparatus according to claim 2,
wherein the one or more search actions in the search event are specified based on a result of comparison between integration relevance and a threshold, the integration relevance being determined based on the group relevance, the threshold being adjusted according to a search ability of a user who performs a search action.

8. The information processing apparatus according to claim 3,
wherein the one or more search actions in the search event are specified based on a result of comparison between integration relevance and a threshold, the integration relevance being determined based on the group relevance, the threshold being adjusted according to a search ability of a user who performs a search action.

9. The information processing apparatus according to claim 4,
wherein the one or more search actions in the search event are specified based on a result of comparison between integration relevance and a threshold, the integration relevance being determined based on the group relevance, the threshold being adjusted according to a search ability of a user who performs a search action.

10. The information processing apparatus according to claim 5,
wherein the one or more search actions in the search event are specified based on a result of comparison between integration relevance and a threshold, the integration relevance being determined based on the group relevance, the threshold being adjusted according to a search ability of a user who performs a search action.

11. The information processing apparatus according to claim 6,
wherein the specifying unit specifies a combination of search actions between which integration relevance is equal to or larger than the threshold, as the one or more search actions in the search event, wherein the threshold increases as the search ability increases.

12. The information processing apparatus according to claim 7,
wherein the specifying unit specifies a combination of search actions between which integration relevance is equal to or larger than the threshold, as the one or more search actions in the search event, wherein the threshold increases as the search ability increases.

13. The information processing apparatus according to claim 8,
wherein the specifying unit specifies a combination of search actions between which integration relevance is equal to or larger than the threshold, as the one or more search actions in the search event, wherein the threshold increases as the search ability increases.

14. The information processing apparatus according to claim 9,
wherein the specifying unit specifies a combination of search actions between which integration relevance is equal to or larger than the threshold, as the one or more search actions in the search event, wherein the threshold increases as the search ability increases.

15. The information processing apparatus according to claim 10,
wherein the specifying unit specifies a combination of search actions between which integration relevance is equal to or larger than the threshold, as the one or more search actions in the search event, wherein the threshold increases as the search ability increases.

16. The information processing apparatus according to claim 6,
wherein the integration relevance is determined based on an action relevance between search actions and the group relevance.

17. The information processing apparatus according to claim 7,
wherein the integration relevance is determined based on an action relevance between search actions and the group relevance.

18. The information processing apparatus according to claim 8,
wherein the integration relevance is determined based on an action relevance between search actions and the group relevance.

19. The information processing apparatus according to claim 9,
wherein the integration relevance is determined based on an action relevance between search actions and the group relevance.

20. A non-transitory computer readable medium storing a program causing a computer to function as:
a group generation unit that generates search action groups including a plurality of search actions, based on occurrence time of each of search actions occurring along a time series; and
a specifying unit that specifies a search action included in an identical search event, based on a group relevance between the search action groups.
